(19) United States
(12) Patent Application Publication
(10) Pub. No.: US 2018/0334141 A1
(43) Pub. Date: Nov. 22, 2018

(54) CHIP FOR A WINDSHIELD WASHER SYSTEM WITH FLEXIBLY DETERMINABLE DIRECTIONAL CHARACTERISTICS

(71) Applicant: ILLINOIS TOOL WORKS INC., Glenview, IL (US)

(72) Inventors: Frank Peralta, Sonderhofen-Bolzhausen (DE); Oscar Medina-Garcia, Bad Mergentheim (DE)

(21) Appl. No.: 15/968,952

(22) Filed: May 2, 2018

(30) Foreign Application Priority Data
May 16, 2017 (DE) 10 2017 110 583.2

(51) Int. Cl. B60S 1/52

(52) U.S. Cl. CPC B60S 1/52; B60Y 2410/122

(57) ABSTRACT

A chip for a windshield washer system of a vehicle front or rear window, wherein the chip is injection-molded by an injection molding process, the chip being arranged to be inserted into a chip holder of the windshield washer system, wherein the chip has a structure for generating a spray beam, wherein the structure has at an end face of the chip an outlet opening having an opening edge, wherein the outlet opening is configured to allow the spray beam to emerge from the chip during operation of the windshield washer nozzle system onto the vehicle front or rear window, wherein the outlet opening is delimited by the opening edge all around the complete opening circumference by the chip, and the opening and the opening edge are formed all around and integrally by the injection molding process.

### TECHNICAL FIELD

The invention relates to a chip for a windshield washer system of a vehicle front or rear window, to a windshield washer system of a vehicle front or rear window with a chip which is held in a chip holder, and to a method for producing a chip for a windshield washer system of a vehicle front or rear window.

### BACKGROUND

A chip or insert body of the type in question is shown in EP 2144702 B1.

US 2005/0195239 A1 likewise shows a chip or insert body of the type in question, which consists of two parts connected by means of a film hinge.

The inventors have found this prior art to be disadvantageous since spray directions of the beam directions which can be produced by the insert body can be defined only to a limited extent and/or potential sealing problems arise because of a two-part design.

It is the object of the present invention to improve these disadvantages.

### SUMMARY

The object is achieved by the independent claims. Advantageous developments are defined in the dependent claims.

In particular, the object is achieved by a chip for a windshield wiper system of a vehicle front or rear window, wherein the chip is injection-molded by an injection molding process, the chip being arranged to be inserted into a chip holder of the windshield washer system, wherein the chip has a structure for generating a spray beam, wherein the structure has at an end face of the chip an outlet opening having an opening edge, wherein the outlet opening is configured to allow the spray beam to emerge from the chip during operation of the windshield washer nozzle system onto the vehicle front or rear window, wherein the outlet opening is delimited by the opening edge all around the complete opening circumference by the chip, and the opening and the opening edge are formed all around and integrally by means of the injection molding process.

The object is furthermore achieved in particular by a windshield washer system of a vehicle front or rear window with a chip according to the invention which is held in a chip holder.

The object is furthermore achieved in particular by a method for producing a chip for a windshield washer system of a vehicle front or rear window, wherein the chip is arranged to be inserted into a chip holder of the window washer system, wherein the chip has a structure for generating a spray beam, wherein the structure has at an end face of the chip an outlet opening and wherein the outlet opening has an opening edge, wherein the outlet opening is configured to allow the spray beam to emerge from the chip during operation of the windshield washer nozzle system onto the vehicle front or rear window; including the step—casting the chip by means of an injection molding process: wherein the opening and the opening edge are formed all around and integrally by means of the injection molding process such that the outlet opening is delimited continuously over the entire opening circumference by the chip by means of the opening edge.

By this means, it is possible to change the outlet direction of the spray beam in any direction, even in the vertical direction. A chip folding design as shown in US 2005/0195239 A1 mentioned at the beginning does not have to be used here.

In a further exemplary embodiment of the present invention, the outlet opening has a central axis and the chip has a horizontal central plane, wherein the central axis is inclined with respect to the horizontal plane at an angle.

This produces a vertically angled spray beam, which is advantageous, for example, for certain windshields. In this case, the chip holder then does not have to be changed in its orientation (or not to the same extent), and a notch or groove also does not have to be provided on the chip holder in order to achieve said angling of the beam all around.

In a further exemplary embodiment of the present invention, the structure is an oscillation structure and the spray beam is an oscillating spray beam.

By this means, the advantages of the invention are achieved above all with an oscillation structure which is sensitive to opening modification—by the provision of an opening which is provided entirely in the chip and is surrounded by the chip, the opening orientation can be changed without the opening profile in partial regions having to change in the process.

In a further exemplary embodiment of the present invention, the chip has a top side and a bottom side, and wherein the chip further comprises two spot beam structures for generating each a respective spot beam, and the spot beam structures are arranged on one of the upper side and lower side, and the oscillation structure is arranged on the corresponding other one of the upper side and lower side, wherein the chip has a collection chamber from which three separate output channels respectively lead to one of the structures.

This permits a highly space-saving arrangement with a simultaneously large collection chamber since the collection chamber can be used for all three structures. In addition, this achieves a uniform generation of a spray beam since less mutual influencing occurs because of the separate channels.

In a further exemplary embodiment of the present invention, the collecting chamber is open towards the upper side and the lower side.

By this means, the collecting chamber can be provided with a very large volume. In contrast to the configuration shown in EP2144702 mentioned at the beginning, separating surfaces between upper side and lower side in the region of the preliminary chamber 20 there and of the collecting chamber 30 there are therefore dispensed with.

In a further exemplary embodiment of the present invention, the collecting chamber extends at least over 50% of the chip width and at least 25% of the chip length.

By this means, a highly uniform supply of the individual structures can be ensured.

In a further exemplary embodiment of the present invention, the output channels which lead to the point beam structures lead across a respective connection opening between the upper side and the lower side.

This achieves an even more uniform production of a spray beam since the length of the separate channels is increased even further, but in a space-saving manner.

The details of one or more embodiments are set forth in the accompanying drawings and the description below. Other features, objects, and advantages will be apparent from the description and drawings, and from the claims.

### BRIEF DESCRIPTION OF THE DRAWINGS

The invention will now be illustrated further by way of example with reference to drawings, in which:

FIG. 1 shows a perspective front view,

FIG. 2 shows a perspective bottom view,

FIG. 3 shows a perspective top view,

FIG. 4 shows a perspective sectional view,

FIG. 5 shows a lateral sectional view of a chip according to the invention for a windshield washer system of a vehicle front or rear window.

### DETAILED DESCRIPTION

The chip 1 is injection-molded by an injection molding process. The chip is arranged to be inserted into a chip holder of the windshield washer system. The chip has structures 10, 20, 30 for generating a spray beam of liquid, wherein the structures 10, 20, 30 each have at an end face of the chip 1 an outlet opening 11, 21, 31 having an opening edge 11.1, 21.1, 31.1. The outlet openings 11, 21, 31 are configured to allow the respective spray beam to emerge from the chip 1 during operation of the windshield washer nozzle system onto the vehicle front or rear window.

The outlet openings 11, 21, 31 are delimited by the respective opening edge 11.1, 21.1, 31.1 all around the complete opening circumference by the chip 1, and the respective opening 11, 21, 31 and the respective opening edge 11.1, 21.1, 31.1 are formed all around and integrally by means of the injection molding process. The outlet opening 11, 21, 31 has a central axis 11.2, see FIG. 5, and the chip 1 has a horizontal central plane 1.5, wherein the central axis 11.2 is inclined with respect to the horizontal plane 1.5 at an angle 11.3. One of the structures 10, 20, 30 is an oscillation structure 10 and the corresponding spray beam is an oscillating spray beam.

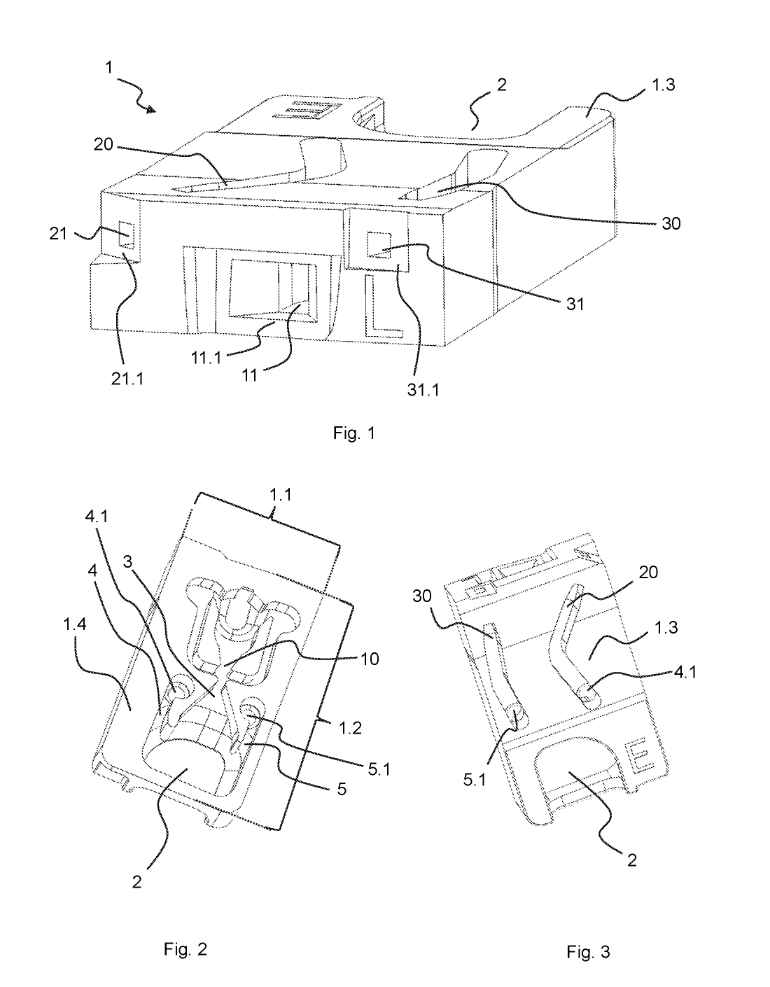

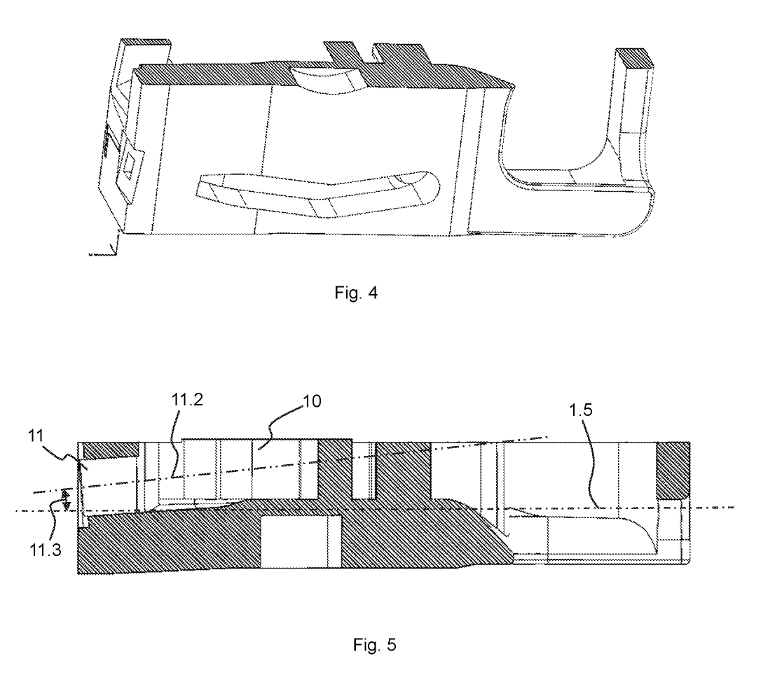

The chip 1 has a top side 1.3, see FIG. 3, and a bottom side 1.4, see FIG. 2. The chip 1 furthermore comprises two spot beam structures 20, 30 for generating each a respective spot beam. The spot beam structures 20, 30 are arranged on the upper side 1.3 and the oscillation structure 10 is arranged on the lower side 1.4. The chip 1 has a collection chamber 2 from which three separate output channels 3, 4, 5 respectively lead to one of the structures 10, 20, 30. The collecting chamber 2 is open towards the upper side 1.3 and the lower side 1.4. The collecting chamber extends at least over 50% of the chip width 1.1 and at least 25% of the chip length 1.2. The output channels 4, 5 which lead to the point beam structures 20, 30 lead across a respective connection opening 4.1, 5.1 between the upper side and the lower side.

It is to be clearly understood that the above description is intended by way of illustration and example only, is not intended to be taken by way of limitation, and that other changes and modifications are possible.

### LIST OF REFERENCE SIGNS

### 1 Chip

1.1 Chip width
1.2 Chip length
1.3 Upper side
1.4 Lower side
1.5 Horizontal central plane
2 Collecting chamber
3 Output channel
4 Output channel
4.1 Connecting opening
5 Output channel
5.1 Connecting opening
10 Oscillation structure
11 Outlet opening
11.1 Opening edge
11.2 Central axis

### 11.3 Angle

20 Spot beam structure
21 Outlet opening
21.1 Opening edge
30 Spot beam structure
31 Outlet opening
31.1 Opening edge

1. A chip (1) for a windshield washer system of a vehicle front or rear window,
wherein the chip (1) is injection-molded by an injection molding process,
the chip (1) being arranged to be inserted into a chip holder of the windshield washer system,
wherein the chip (1) has a structure (10, 20, 30) for generating a spray beam,
wherein the structure (10, 20, 30) has at an end face of the chip (1) an outlet opening (11, 21, 31) having an opening edge (11.1, 21.1, 31.1),
wherein the outlet opening (11, 21, 31) is configured to allow the spray beam to emerge from the chip (1) during operation of the windshield washer nozzle system onto the vehicle front or rear window,
wherein the outlet opening (11, 21, 31) is delimited by the opening edge (11.1, 21.1, 31.1) all around the complete outlet opening circumference by the chip (1),
and the outlet opening (11, 21, 31) and the opening edge (11.1, 21.1, 31.1) are formed all around and integrally by means of the injection molding process.

2. The chip (1) as claimed in claim 1, wherein the outlet opening (11, 21, 31) has a central axis (11.2) and the chip has a horizontal central plane (1.5), wherein the central axis (11.2) is inclined with respect to the horizontal central plane (1.5) at an angle (11.3).

3. The chip (1) as claimed in claim 1, wherein the structure (10) is an oscillation structure (10) and the spray beam is an oscillating spray beam.

4. The chip (1) as claimed in claim 3, wherein the chip (1) has a top side (1.3) and a bottom side (1.4), and wherein the chip (1) further comprises two spot beam structures (20, 30) for generating each a respective spot beam, and wherein the spot beam structures (20, 30) are arranged on one of the upper side (1.3) and the lower side (1.4), and the oscillation structure (10) is arranged on the corresponding other one of the upper side (1.3) and lower side (1.4), wherein the chip (1) has a collection chamber (2) from which three separate output channels (3, 4, 5) respectively lead to one of the structures (10, 20, 30).

5. The chip (1) as claimed in claim 4, wherein the collecting chamber (2) is open towards the upper side (1.3) and the lower side (1.4).

6. The chip (1) as claimed in claim 5, wherein the collecting chamber extends at least over 50% of the chip width (1.1) and at least 25% of the chip length (1.2).

7. The chip as claimed in claim 6, wherein the output channels (4, 5) which lead to the point beam structures (20, 30) lead across a respective connection opening (4.1, 5.1) between the upper side (1.3) and the lower side (1.4).

8. A windshield washer system of a vehicle front or rear window with a chip (1) as claimed in claim 1, which is held in a chip holder on the vehicle.

9. A method for producing a chip (1) for a windshield washer system of a vehicle front or rear window, wherein the chip (1) is arranged to be inserted into a chip holder of the window washer system,
wherein the chip (1) has a structure (10, 20, 30) for generating a spray beam,
wherein the structure (10, 20, 30) has at an end face of the chip (1) an outlet opening (11, 21, 31) having an opening edge (11.1, 21.1, 31.1),
wherein the outlet opening (11, 21, 31) is configured to allow the spray beam to emerge from the chip (1) during operation of the windshield washer nozzle system onto the vehicle front or rear window;
including the step
casting the chip (1) by means of an injection molding process:
wherein the opening (11, 21, 31) and the opening edge (11.1, 21.1, 31.1) are formed all around and integrally by means of the injection molding process such that the outlet opening (11, 21, 31) is delimited continuously over the entire opening circumference by the chip (1) by means of the opening edge (11.1, 21.1, 31.1).

10. A chip for a windshield washer system of a vehicle front or rear window,
wherein the chip (1) is injection-molded by an injection molding process,
the chip configured to be inserted into a chip holder of the windshield washer system,
wherein the chip has at least one structure for generating a spray beam,
wherein the structure has an outlet opening at an end face of the chip, the outlet opening having an opening edge,
wherein the outlet opening is configured to allow the spray beam to emerge from the chip during operation of the windshield washer nozzle system onto the vehicle front or rear window,
wherein the outlet opening is delimited by the opening edge all around a complete periphery of the outlet opening, and the opening edge is part of the chip,
and the outlet opening and the opening edge are formed all around and integrally by means of the injection molding process.

11. The chip as claimed in claim 10, wherein the outlet opening has a central axis and the chip has a horizontal central plane, wherein the central axis is inclined with respect to the horizontal central plane at an angle offset from zero.

12. The chip as claimed in claim 10, wherein the at least one structure is an oscillation structure and the spray beam is an oscillating spray beam.

13. The chip as claimed in claim 12, wherein the chip has a top side and a bottom side, and wherein the chip further comprises two spot beam structures for generating each a respective spot beam, and wherein the spot beam structures are arranged on one of the upper side and the lower side, and the oscillation structure is arranged on the other one of the upper side and the lower side, wherein the chip has a collection chamber from which three separate output channels, each output channel leading to a respective one of the oscillating structure or the beam structures.
